(19) United States
(12) Patent Application Publication
(10) Pub. No.: US 2009/0077256 A1
(43) Pub. Date: Mar. 19, 2009

(54) Dynamic change of quality of service for enhanced multi-media streaming

(75) Inventor: Vaibhav Madan, Delhi (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MBIT WIRELESS, INC., Newport Beach, CA (US)

(21) Appl. No.: 12/283,952

(22) Filed: Sep. 17, 2008

Related U.S. Application Data
(60) Provisional application No. 60/993,978, filed on Sep. 17, 2007.

(51) Int. Cl. G06F 15/16

(52) U.S. Cl. 709/231

(57) ABSTRACT

The present invention describes a method and apparatus to change the QoS automatically to minimize the initial delay in multimedia streaming. Additional QoS parameters may be used to enable the automatic selection of initial data rate and transition to steady state date rate. The method enhances the user experience with minimum processing overhead.

### CROSS-REFERENCE TO RELATED APPLICATION

The present application claims the benefit of the filing date of U.S. Provisional Patent Application No. 60/993,978, filed Sep. 17, 2007, and entitled “Dynamic Change of QoS to Enhance Multi-media Streaming,” the entire disclosure of which is hereby expressly incorporated by reference herein.

### BACKGROUND OF THE INVENTION

1. Field of the Invention

The present invention relates generally to data communication systems and, more particularly, to methods for streaming multi-media content over data communication systems.

2. Description of Related Art

Data streaming is a method of transferring data that has real-time characteristics between a transmit entity and a receive entity so that the receive entity may start presenting partially received data before the entire contents may have been transmitted by the transmit entity or received by the receive entity. Typically the data content in streaming applications may be audio, video or both. Therefore the data content in data streaming applications may be often referred to as media or multimedia. The term streaming refers herein to the delivery method of multimedia. The terms data streaming, media streaming and multimedia streaming are used interchangeably herein.

The streaming method of transferring content is different from the other commonly used method of transferring media normally referred to as downloading. When downloading media, the receive entity normally first receives the entire content and saves it to a local storage and only after the entire content is received by the receive entity, it may then start the presentation of the media. The terms “media” and “content” are used interchangeably herein.

A communication system normally comprises a network entity which provides services and the terminals which use the services. The network entity is referred to herein as a server and the terminals are referred to herein as clients. The terms users, clients, client terminals, and client devices are used interchangeably herein. Also the terms server, network and network entity are used interchangeably herein. In this context, normally a transmit entity for media streaming may be generally located in the network and the receive entity may be one or more client terminals. In some applications, the transmit entity may be a terminal and the receive entity may also be a terminal.

Normally there are two types of data streaming namely “on-demand streaming” and “live streaming.” The contents for on-demand streaming may be stored in a server and may be available at client's request, for example the recording of a sporting event. The contents for live streaming may be only available at a particular time, for example streaming of a live sporting event. Normally, contents of live streaming may become available for on-demand streaming after the initial live streaming.

Different communication protocols have been developed for media streaming. Unicast protocols send a separate copy of the media content from the server to each client as shown in FIG. 1. Unicast protocols are commonly used for most Internet connections. However unicast protocols may not be efficient when many users want to view or listen to the same media concurrently such as in live streaming. Therefore, unicast protocols may be well suited for on-demand streaming.

Multicast protocols send a single stream of media from the server to a group of clients as shown in FIG. 2. Multicast protocols are commonly used when many users want to view or listen to the same media concurrently such as in live streaming. Multicast protocols reduce the data replication and consequent server loads when compared to many independent streams sent by the server when using unicast protocols. Multicast protocols may be suitable for live streaming whereas unicast protocols may be suitable for on-demand streaming.

The Open Systems Interconnection (“OSI”) Basic Reference Model is a layered, abstract description for communication systems and computer networks as shown in FIG. 3. Many communication systems are normally designed according to the OSI layered model. A layer is a collection of related functions that provides services to the layer above it and receives services from the layer below it. In a layered model of a communication system, there are different processing entities in each layer at both ends of a communication system.

A processing entity in each layer at one end of a communication system normally communicates with a processing entity at the same layer at the other end of the communication system. The processing entities at the same hierarchical layer at any two ends of a communication system, referred as peers, is illustrated in FIG. 3. For example the physical layer at one end of the communication system is peer to the physical layer at the other end of the communication system as illustrated in FIG. 3.

There may be different communication protocols defined for each layer. The peers at each layer communicate with each other using these protocols. Also each peer entity normally communicates with the processing entities in the layer above it and the layer below it. The unit of data exchanged at a given layer is referred as a Protocol Data Unit (“PDU”). The names of the PDUs at different layers may be different in different communication systems. For example, a PDU at the network layer is referred as an N-PDU and a PDU at the transport later is referred as a T-PDU. Often PDUs are also referred as packets.

A protocol entity in one layer may often format the PDUs received from its adjacent layers into a structure that is more suitable for further processing in its own layer. A typical PDU may have two kinds of information, namely control information and user data. Control information is also referred as control messages. Control messages are used by peer entities to setup, modify, maintain, and release data transfer between two entities. Often, user data is also referred to as payload data.

While data streaming is relatively a new method of media delivery, traditional communication protocols such as User Datagram Protocol (“UDP”), Transmission Control Protocol (“TCP”), and Internet Protocol (“IP”) that are used in data communication networks, such as the Internet, may also be suitable for data streaming. However, the streaming nature of real-time content requires additional measures in the protocols used for the end-to-end delivery of the streaming media. FIG. 4 shows commonly used protocols at different layers in media streaming applications.

In a communication system, Quality of Service (“QoS”) refers to resource reservation and control mechanisms. QoS enables the ability to provide different priorities to different applications, users, or data flows, or to guarantee a certain level of performance to a data flow. Some communication system may use one or more of the following parameters for defining QoS: minimum sustained data rate, maximum sustained data rate, maximum tolerated delay or latency, maximum tolerated jitter, average Bit Error Rate (“BER”), average Packet Error Rate (“PER”), Traffic Priority, etc.

QoS is especially important for real-time streaming of multimedia applications such as Voice over IP (“VoIP”), online gaming and Internet-TV, since these multimedia applications may often require certain guaranteed data rate, maximum tolerable delay, BER, etc. For different applications, the QoS parameters may need to have different values. For simplifying the service provisioning, often a set of QoS parameter values are defined for a particular application. A particular set of values of QoS parameters is often referred to as a QoS profile.

A protocol entity at the server may negotiate the QoS profile with its peer protocol entity at the client for a given media streaming. Once the QoS is negotiated, the protocol entities may reserve the capacity at different nodes in the communication system to meet the QoS guarantees for the given media streaming. During media streaming, the protocol entities may monitor some parameters of QoS, for example the average data rate, the delay, and the BER to check the achieved level of QoS and dynamically control the scheduling priorities in the network nodes. The protocol entities may release the reserved capacity during the termination phase of the given media streaming.

The QoS parameter “delay” refers to the time taken by a packet to travel from its source to the destination. The required time may include queuing time at different nodes in the communication network, processing time at different nodes in the communication network, and the propagation time from the source to the destination. The amount of delay may depend on the congestion in the network, the route taken by the packet from the source to destination, and other factors. The QoS parameter “jitter” refers to the fluctuation in the time taken by different packets to reach the receiver. Delay and jitter may seriously affect the quality of media streaming.

Normally for different applications such as VoIP, multimedia streaming, email, file transfer, etc., the communication system may define different QoS profiles. The server and the client may negotiate and agree upon a particular QoS profile for a given service. The terms applications and services are used interchangeably herein.

Real-time interactive applications such as VoIP are very sensitive to delay and jitter. Streaming applications such as watching a video clip over the Internet may be relatively less sensitive to delay than real-time interactive applications. Applications such as email and file transfers may not be particularly sensitive to delay and jitter.

For many applications, the data rate requirement is one of the important parameters of QoS. The data rate requirement is normally defined in terms of bits per second (“bps”) or Kilobits per second (“Kbps”) or Megabits per second (“Mbps”). For many applications the average data rate requirement is specified. However, the instantaneous data rate may fluctuate depending on network conditions. For example, in some communication systems the channel bandwidth is shared among multiple users, which may contribute to the fluctuation to the instantaneous data rate.

In some communication systems, the BER may fluctuate depending on channel conditions such as fading, interference, etc. Therefore, the instantaneous data rate available to a particular client may be lower or higher than the average data rate necessary for the application. This in turn may lead to further variations in the arrival times of the packets at the receiver and this is one of the contributing factors to the jitter.

The problem caused by jitter may be addressed at the receiving entity by first buffering the received data before presenting it to the user as shown in FIG. 5. The size of the buffer may depend on the expected jitter and the average data rate for a given service. The buffer that is used to minimize the effect of jitter is referred herein as a de-jitter buffer. A small de-jitter buffer is desirable to minimize the delay in presenting the received data. However, to minimize the probability of interruption in presenting the received data the de-jitter buffer may need to be larger. For real-time interactive applications such as VoIP, a smaller de-jitter buffer is desirable to reduce the overall end-to-end delay in voice communication. For streaming applications a relatively larger delay may be tolerable and therefore a larger de-jitter buffer may be used. The de-jitter buffer size normally depends on the duration for the media to be buffered and the data rate of the service.

The use of de-jitter buffer may introduce an initial delay in addition to the normal transmission delay for the data to travel from the transmit entity to the receive entity. This additional delay causes degradation in the user experience in media streaming. For instance, let the average data rate required by the streaming application be denoted by R bps. Let the duration for which the received data needs to be buffered be denoted by T_{b}. Therefore the total number of bits that may need to be buffered for the period T_{b} is referred herein as B is equal to R×T_{b} bits. The additional delay D_{b}, referred to herein as the buffering delay, is caused by buffering the received data to minimize interruption in data presentation. The additional delay D_{b}=B/R_{b}=T_{b}. The relationship between the buffering delay and the start of presentation and total presentation time is illustrated in FIG. 6. The required buffering delay, for example, may be in terms of several tens of seconds depending on the QoS of a given service.

In traditional data communication systems, the QoS may not address the initial delay caused by the de-jitter buffer.

### SUMMARY OF THE INVENTION

The present invention provides for methods and apparatuses to change QoS automatically to minimize initial delays in multimedia streaming.

In accordance with an embodiment of the present invention, a method of managing quality of service in a multimedia streaming system is provided. The method comprises determining an initial quality of service profile defining an initial data transmission rate of multimedia content between a server and a client; determining a steady state quality of service profile defining a subsequent data transmission rate of the multimedia content between the server and the client; and setting a predefined point during streaming for switching over from the initial data transmission rate to the subsequent data transmission rate without handshaking between the server and the client at the switchover. The predefined point is set to minimize an initial delay in streaming the multimedia content from the server to the client. Furthermore, the initial data transmission rate is higher than the subsequent data transmission rate.

In one alternative, the higher initial data transmission rate is achieved by allocating additional channel resources to the multimedia content streaming.

In another alternative, the initial data transmission rate is defined based upon an available buffer size of a buffer of the client. In this case, at least one of the client and the server may determine the available buffer size.

In a further alternative, the initial data transmission rate and the predefined point are determined by at least one of an average data rate requested by a user and a maximum data rate supported by the client.

In accordance with another embodiment of the present invention, a method of managing quality of service in a multimedia streaming system is provided. The method comprises determining an average rate R of transmission for multimedia content to be streamed between a server and a client; determining a number of bits B of the multimedia content to buffer at the client; setting a maximum tolerable initial delay Dᵢ as part of an initial quality of service profile, wherein Dᵢ≦B/R; setting an initial data rate Rᵢ, wherein data of the multimedia content will be transferred at the rate Rᵢ for Dᵢ seconds; and setting a steady state data rate for continued streaming of the multimedia content. The data of the multimedia content will be transferred at the steady state data rate after Dᵢ seconds have elapsed and the initial data rate Rᵢ is higher than the steady state data rate. Switching from the initial data rate Rᵢ to the steady state data rate occurs automatically without handshaking between the server and the client.

In one example, the initial data rate Rᵢ=B/Dᵢ. In another example, the server sets the initial data rate Rᵢ to be no greater than a maximum data rate supported by the client based on the initial quality of service profile.

In a further embodiment of the present invention, a client device for use on a communication network to receive streaming multimedia content is provided. The client device comprises a baseband subsystem and a receiver subsystem. The baseband subsystem includes a processor for managing operations of the client device and a buffer for buffering a portion of the streamed multimedia content. The receiver subsystem is operatively connected to the baseband subsystem. The receiver subsystem is operable to receive data packets of the streamed multimedia content from a server on the communication network and to perform at least one of transport layer and network layer protocol management on the streamed data packets. The processor is operable to set an average data rate of transmission R of the streaming multimedia content from the server to the client device; identify a maximum tolerable delay Dᵢ; and identify a number of bits B to be buffered in the buffer. The number of bits B is selected to avoid jitter of the streamed multimedia content. The processor is also operable to determine whether a proposed initial data rate Rᵢ is permissible according to an initial quality of service profile. If the proposed initial data rate Rᵢ is permissible, streaming of the multimedia content switches from the initial data rate Rᵢ to a steady state data rate less than the initial data rate Rᵢ automatically after the maximum tolerable delay Dᵢ without handshaking between the server and the client device.

In one alternative, the proposed initial data rate Rᵢ=B/Dᵢ. In another alternative, the proposed initial data rate Rᵢ is set to be no greater than a maximum data rate supported by the client based on the initial quality of service profile. In a further alternative, the proposed initial data rate Rᵢ is achieved by allocating additional channel resources to the multimedia content streaming. And in another alternative, the proposed initial data rate Rᵢ is determined by at least one of the average data rate of transmission R and a maximum data rate supported by the client device.

In accordance with a further embodiment of the present invention, a server for use on a communication network to receive streaming multimedia content is provided. The server comprises a baseband subsystem including a processor for managing operations of the server and a transmitter subsystem operatively connected to the baseband subsystem. The transmitter subsystem is operable to prepare and stream data packets of the multimedia content to a client device on the communication network and to perform at least one of transport and network layer protocol management on the data packets. The processor is operable to receive an average data rate of transmission R of the streaming multimedia content from the client device; receive an indication of a maximum tolerable delay Dᵢ; and receive an indication of a number of bits B to be buffered in a buffer of the client device. The number of bits B is selected to avoid jitter of the streamed multimedia content. The processor is also operable to determine an initial data rate Rᵢ based on the maximum tolerable delay Dᵢ and the number of bits B. The processor is further operable to switch streaming the multimedia content from the initial data rate Rᵢ to a steady state data rate less than the initial data rate Rᵢ automatically after the maximum tolerable delay Dᵢ without handshaking between the server and the client device.

In one alternative, the initial data rate Rᵢ=B/Dᵢ. In another alternative, the initial data rate Rᵢ is set to be no greater than a maximum data rate supported by the client based on an initial quality of service profile. In a further alternative, the initial data rate Rᵢ is achieved by the server allocating additional channel resources to the multimedia content streaming. And in another alternative, the initial data rate Rᵢ is determined by at least one of the average data rate of transmission R and a maximum data rate supported by the client device.

In yet another embodiment of the present invention, a computer-readable recording medium is provided. The recording medium is recorded with a computer program for execution by a processor to perform a process to manage quality of service in a multimedia streaming system. The process comprises determining an initial quality of service profile defining an initial data transmission rate of multimedia content between a server and a client; determining a steady state quality of service profile defining a subsequent data transmission rate of the multimedia content between the server and the client; and setting a predefined point during streaming for switching over from the initial data transmission rate to the subsequent data transmission rate without handshaking between the server and the client at the switchover. The predefined point is set to minimize an initial delay in streaming the multimedia content from the server to the client. Furthermore, the initial data transmission rate is higher than the subsequent data transmission rate.

And in accordance with another embodiment of the present invention, a computer-readable recording medium is provided. The recording medium is recorded with a computer program for execution by a processor to perform a process to manage quality of service in a multimedia streaming system. The process comprises determining an average rate R of transmission for multimedia content to be streamed between a server and a client; determining a number of bits B of the multimedia content to buffer at the client; setting a maximum tolerable initial delay Dᵢ as part of an initial quality of service profile, wherein Dᵢ≦B/R; setting an initial data rate Rᵢ, wherein data of the multimedia content will be transferred at the rate Rᵢ for Dᵢ seconds; and setting a steady state data rate for continued streaming of the multimedia content. The data of the multimedia content will be transferred at the steady state data rate after Dᵢ seconds have elapsed. The initial data rate Rᵢ is higher than the steady state data rate. And switching from the initial data rate Rᵢ to the steady state data rate occurs automatically without handshaking between the server and the client.

### BRIEF DESCRIPTION OF THE DRAWINGS

FIG. 1 illustrates a unicast packet transmission scenario.

FIG. 2 illustrates a multicast packet transmission scenario.

FIG. 3 illustrates an OSI Layered Reference model for communication systems.

FIG. 4 illustrates a model for protocols used for real-time applications over packet data communication systems.

FIG. 5 illustrates the use of buffering to minimize interruptions in data streaming due to jitter in the arrival times of the received packets.

FIG. 6 illustrates the delays caused by the use of de-jitter buffer at the receive entity.

FIG. 7 illustrates an aspect of the invention that minimizes the initial delay in streaming applications.

FIG. 8 illustrates an exemplary client server model of a communication system.

FIG. 9 illustrates an exemplary client terminal for use with aspects of the present invention.

FIG. 10 illustrates an exemplary baseband subsystem for use with aspects of the present invention.

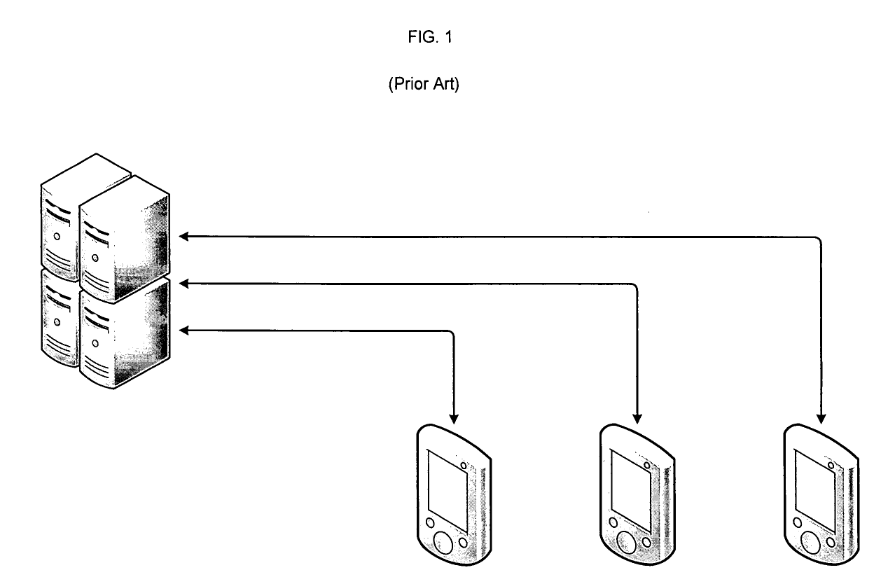

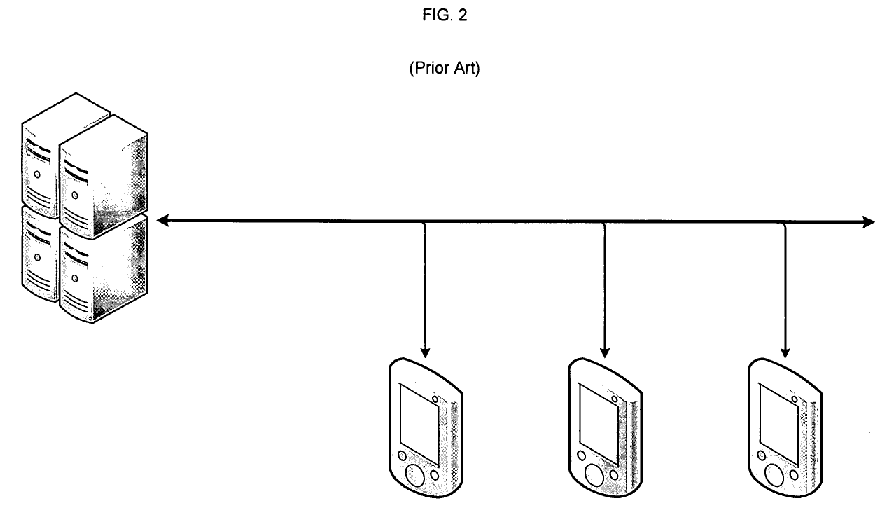

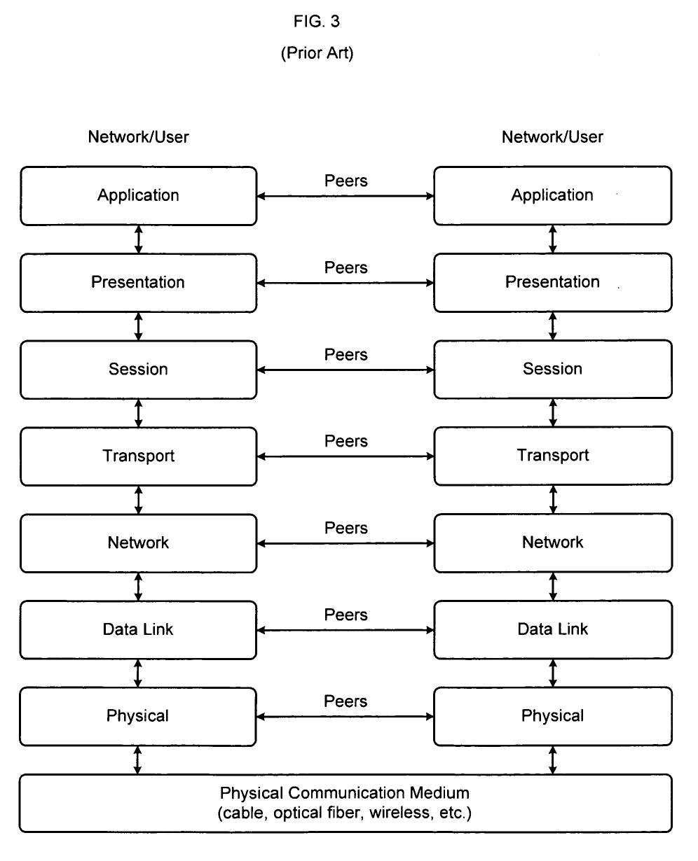

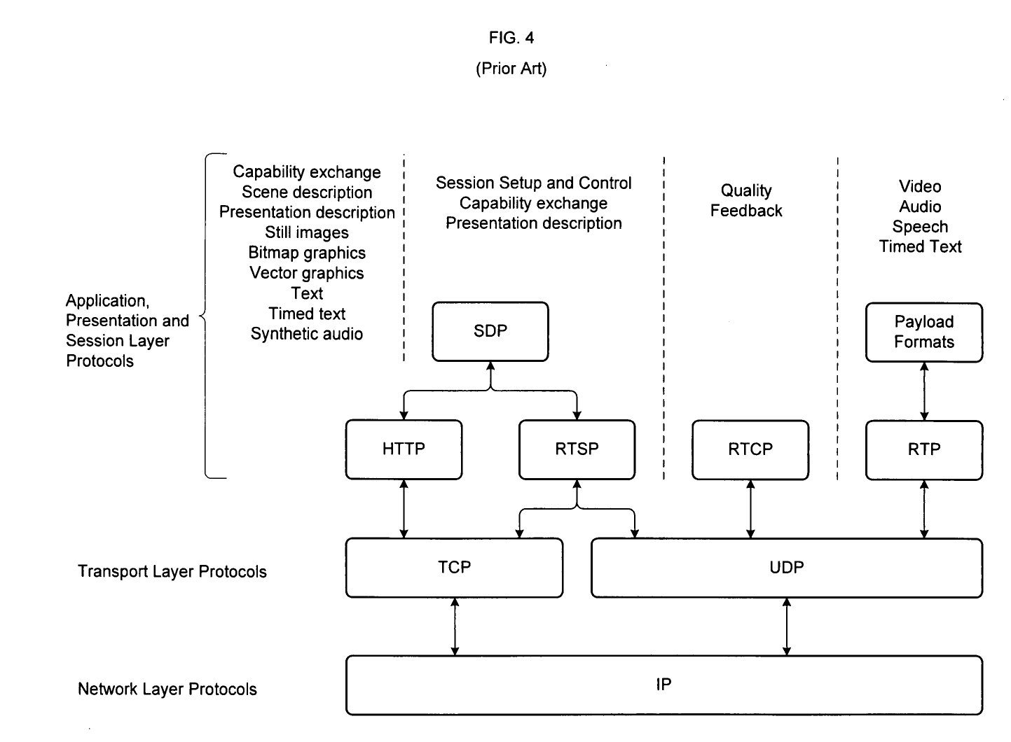

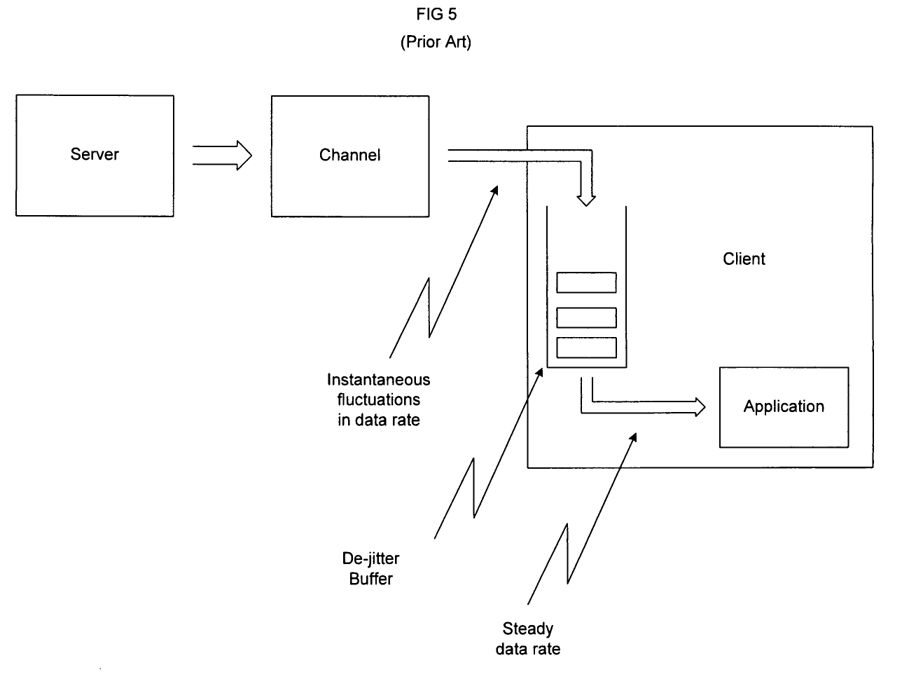

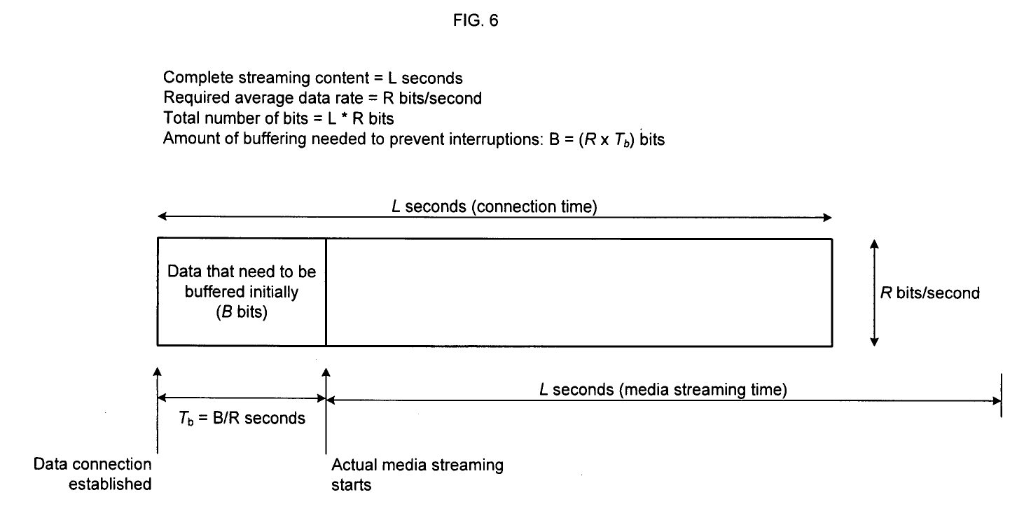

### DETAILED DESCRIPTION

The foregoing aspects, features and advantages of the present invention will be further appreciated when considered with reference to the following description of preferred embodiments and accompanying drawings, wherein like reference numerals represent like elements. In describing the preferred embodiments of the invention illustrated in the appended drawings, specific terminology will be used for the sake of clarity. However, the invention is not intended to be limited to the specific terms used.

This invention includes methods and apparatuses to change the QoS automatically to minimize the initial delay in multimedia streaming. The QoS profiles described herein allow the communication system to increase the initial data rate and then automatically change the data rate after a period of time sufficient enough to minimize the initial delay in multimedia streaming. For instance, this period of time may be measured in milliseconds, seconds, minutes, etc., depending upon the type of content being streamed. The QoS profile required to enable higher data rate for a given application is referred herein as “initial QoS profile” and the QoS profile required to enable average data rate for a given application is referred herein as “steady state QoS profile.”

Various parameters such as the ability of the network and the client to support initial higher data rate, the availability of the network resources to support the initial higher data rate, etc., may be used to define the initial QoS profile. According to an aspect of the invention, first the initial QoS profile is assigned to achieve higher data rate and then the QoS profile is automatically changed to the steady state QoS profile after a pre-determined period of time, e.g., after t ms.

According to another aspect of the invention, the higher data rate of the initial QoS profile may be achieved by allocating additional channel resources. For example, in some communication systems, the higher data rate may be achieved by increasing the channel resources for the initial QoS profile.

According to a further aspect of the invention, the client may indicate its maximum tolerable initial delay in the list of QoS parameter values. The server uses this maximum tolerable initial delay to determine the required initial higher data rate based on other QoS parameters.

The initial higher data rate and its duration may be determined using other QoS parameters such as the average data rate requested by the user, the maximum data rate that the client terminal may be able to accept, etc.

According to a further aspect of the invention, the client, the server, or both may negotiate the size of the de-jitter buffer. By way of example, the size of the de-jitter buffer may be constrained by physical memory size and/or resource allocation limits of the client. This in turn may be used by the server to automatically determine the initial higher data rate and the duration for which initial higher data rate may be sustained.

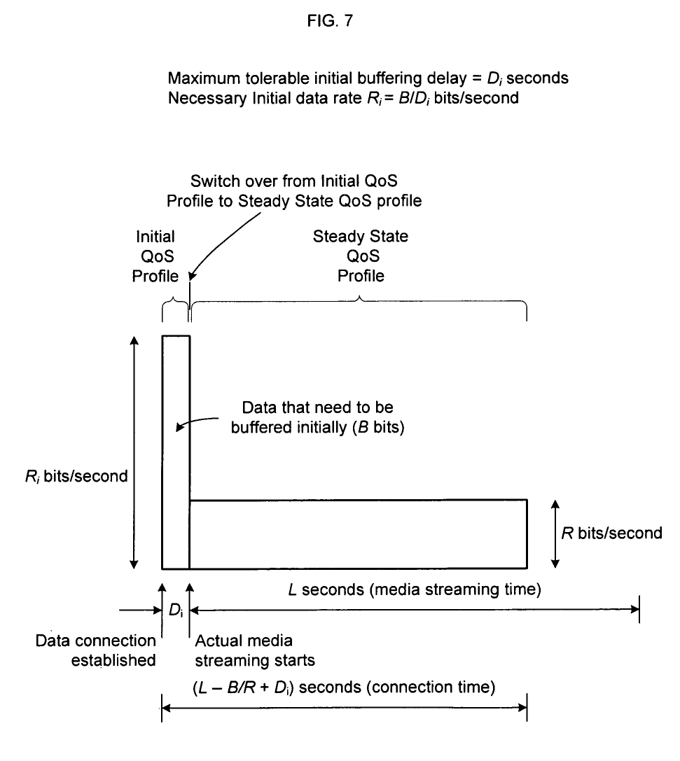

FIG. 7 illustrates an example of the present invention when applied to a multi-media streaming application. In the chosen example, the client requires an average data rate of R bps. The client indicates to the server that the maximum tolerable delay is Dᵢ seconds and the number of bits to be buffered is B bits. The initial buffering delay may be B/R seconds if the server transmits data at the requested average data rate of R bps. In the chosen example, Dᵢ<(B/R).

According to an aspect of the present invention, the server computes the required initial higher data rate Rᵢ=B/Dᵢ. The server also determines that it needs to maintain the initial higher data rate Rᵢ for Dᵢ seconds. The server ensures that the initial higher data rate is at or below the maximum data rate that the client may accept according to its QoS parameter values. When compared to the traditional method, the initial delay in multimedia streaming may be reduced by (B/R)−Dᵢ seconds as shown in FIG. 7 while maintain the same amount of buffering to address the jitter in the arrival times of the data at the receiver.

Normally peer entities may exchange control messages to change some of the QoS parameter values such as the data rate for the duration of the given service. However, this traditional method tends to be slow as several control messages need to be exchanged before any real change in the QoS may take place within a given service. An aspect of the invention is to automatically change the QoS profile from the initial QoS profile to the steady state QoS profile and it avoids the need for exchanging additional control messages to change the QoS. The aspect to automatically change the QoS profile may result in change of the QoS profile in a timely manner.

The present invention is used in streaming applications over data communication systems that have data rates that can be changed dynamically. Also it is expected that the client is able to accept data rates that are higher than the average data rates for a short period of time. Aspects of the present invention offer the following advantages. Enhanced user experience by minimizing the initial delay. Automatic and timely change of QoS profiles. Improved throughput of the overall communication system by avoiding un-necessary exchange of control messages. Reduced unnecessary processing at the server and at the client. And reduced overall data connection time while keeping the total amount of data transfer the same.

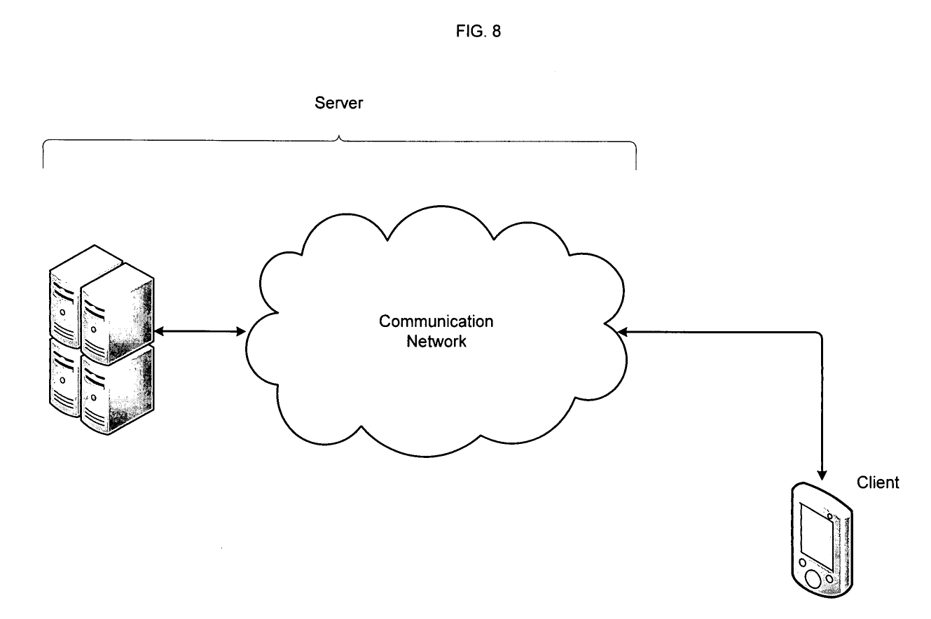

By way of example only, the above-described methods may be implemented both in the server and in the client as shown in FIG. 8.

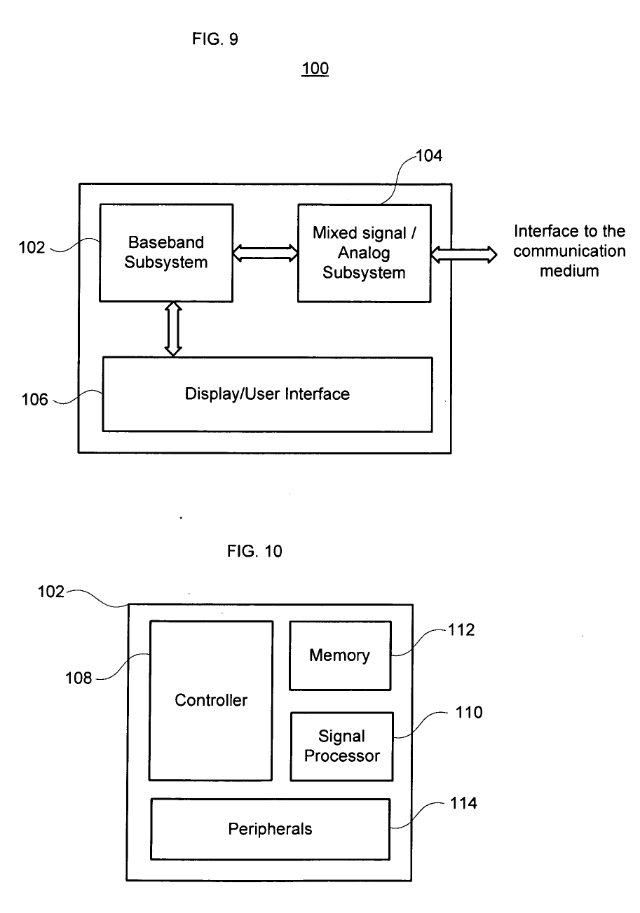

The client may be a stationary device or a wireless mobile station (“MS”), which are collectively referred to herein as client terminals. As shown in FIG. 9, a client terminal 100 may include a baseband subsystem 102 and a mixed signal/analog subsystem 104 for interfacing with the communication medium such as a DSL line, coaxial cable, fiber optics cable or a wireless channel. In case of a wireless communication medium the mixed signal subsystem may include Radio Frequency (RF) circuitry/elements. A display/user interface 106 provides information to and receives input from the user. By way of example, the user interface may include one or more actuators, a speaker and a microphone.

The baseband subsystem 102 as shown in FIG. 10 may include a controller 408 such as a microcontroller or other processor. The controller 108 desirably handles overall operation of the MS 100, including management of the mixed signal/analog subsystem 104. This may be done by software or firmware running on the controller 108. Such software/firmware may embody any methods in accordance with aspects of the present invention.

A signal processor 110 may be used to process samples from the mixed signal/analog subsystem 104 or other information sent or received by the MS 100. The signal processor 110 may be a stand-alone component or may be part of the controller 108. Memory 112 may be shared by or reserved solely for one or both of the controller 108 and the signal processor 110. For instance, signal processing algorithms may be stored in a non-volatile section of memory 112 while coefficients and other data parameters may be stored in RAM. Peripherals 114 such as a full or partial keyboard, video or still image display, audio interface, etc may be employed and managed through the controller 108.

The mixed signal/analog subsystem 104 preferably provides two-way communication operation. It may include one or more receivers/receive chains, a transmitter, a power amplifier, and analog interfaces operatively coupled together to enable communication. In case of wireless client terminals, the mixed signal/analog subsystem 104 may include frequency synthesizers and other RF elements such as one or more antennas that operatively couple together to enable wireless communication.

Aspects of the present invention may be implemented in firmware of the controller 108 and/or signal processor 110 of the baseband subsystem. In another alternative, aspects of the present invention may also be implemented as a combination of firmware and hardware of the baseband subsystem. The software may reside in internal or external memory and any data may be stored in such memory. The hardware may be an application specific integrated circuit (“ASIC”), field programmable gate array (“FPGA”), discrete logic components or any combination of such devices. The terms controller and processor are used interchangeably herein.

The server may communicate with the client through a wire line or wireless communication network or the server itself is part of the communication network. All the elements that are associated in providing service to client are collectively referred herein as server. The aspects of the present invention may be implemented in the server. For instance, the server may employ one or more controller or a signal processor subsystem such as those detailed above. Software and/or firmware embodying any of the methods in accordance with aspects of the present invention may be executed by a controller or signal processor.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. Method steps may be performed in different orders unless expressly stated otherwise. Aspects of each embodiment may be employed in the other embodiments described herein.

1. A method of managing quality of service in a multimedia streaming system, the method comprising:
determining an initial quality of service profile defining an initial data transmission rate of multimedia content between a server and a client;
determining a steady state quality of service profile defining a subsequent data transmission rate of the multimedia content between the server and the client; and
setting a predefined point during streaming for switching over from the initial data transmission rate to the subsequent data transmission rate without handshaking between the server and the client at the switchover;
wherein the predefined point is set to minimize an initial delay in streaming the multimedia content from the server to the client and wherein the initial data transmission rate is higher than the subsequent data transmission rate.

2. The method of claim 1, wherein the higher initial data transmission rate is achieved by allocating additional channel resources to the multimedia content streaming.

3. The method of claim 1, wherein the initial data transmission rate is defined based upon an available buffer size of a buffer of the client.

4. The method of claim 3, wherein at least one of the client and the server determine the available buffer size.

5. The method of claim 1, wherein the initial data transmission rate and the predefined point are determined by at least one of an average data rate requested by a user and a maximum data rate supported by the client.

6. A method of managing quality of service in a multimedia streaming system, the method comprising:
determining an average rate R of transmission for multimedia content to be streamed between a server and a client;
determining a number of bits B of the multimedia content to buffer at the client;
setting a maximum tolerable initial delay Dᵢ as part of an initial quality of service profile, wherein Dᵢ≦B/R;
setting an initial data rate Rᵢ, wherein data of the multimedia content will be transferred at the rate Rᵢ for Dᵢ seconds; and
setting a steady state data rate for continued streaming of the multimedia content, wherein the data of the multimedia content will be transferred at the steady state data rate after Dᵢ seconds have elapsed, the initial data rate Rᵢ being higher than the steady state data rate;
wherein switching from the initial data rate Rᵢ to the steady state data rate occurs automatically without handshaking between the server and the client.

7. The method of claim 6, wherein the initial data rate Rᵢ=B/Dᵢ.

8. The method of claim 6, wherein the server sets the initial data rate Rᵢ to be no greater than a maximum data rate supported by the client based on the initial quality of service profile.

9. A client device for use on a communication network to receive streaming multimedia content, the client device comprising:
a baseband subsystem including a processor for managing operations of the client device and a buffer for buffering a portion of the streamed multimedia content; and
a receiver subsystem operatively connected to the baseband subsystem, the receiver subsystem being operable to receive data packets of the streamed multimedia content from a server on the communication network and to perform at least one of transport layer and network layer protocol management on the streamed data packets;
the processor being operable to:
set an average data rate of transmission R of the streaming multimedia content from the server to the client device;
identify a maximum tolerable delay Dᵢ;
identify a number of bits B to be buffered in the buffer, the number of bits B being selected to avoid jitter of the streamed multimedia content; and
determine whether a proposed initial data rate Rᵢ is permissible according to an initial quality of service profile;
wherein if the proposed initial data rate Rᵢ is permissible, streaming of the multimedia content switches from the initial data rate Rᵢ to a steady state data rate less than the initial data rate Rᵢ automatically after the maximum tolerable delay Dᵢ without handshaking between the server and the client device.

10. The client device of claim 9, wherein the proposed initial data rate Rᵢ=B/Dᵢ.

11. The client device of claim 9, wherein the proposed initial data rate Rᵢ is set to be no greater than a maximum data rate supported by the client based on the initial quality of service profile.

12. The client device of claim 9, wherein the proposed initial data rate Rᵢ is achieved by allocating additional channel resources to the multimedia content streaming.

13. The client device of claim 9, wherein the proposed initial data rate Rᵢ is determined by at least one of the average data rate of transmission R and a maximum data rate supported by the client device.

14. A server for use on a communication network to receive streaming multimedia content, the server comprising:
a baseband subsystem including a processor for managing operations of the server; and
a transmitter subsystem operatively connected to the baseband subsystem, the transmitter subsystem being operable to prepare and stream data packets of the multimedia content to a client device on the communication network and to perform at least one of transport and network layer protocol management on the data packets;
the processor being operable to:
receive an average data rate of transmission R of the streaming multimedia content from the client device;
receive an indication of a maximum tolerable delay Dᵢ;
receive an indication of a number of bits B to be buffered in a buffer of the client device, the number of bits B being selected to avoid jitter of the streamed multimedia content; and
determine an initial data rate Rᵢ based on the maximum tolerable delay Dᵢ and the number of bits B;
wherein the processor is further operable to switch streaming the multimedia content from the initial data rate Rᵢ to a steady state data rate less than the initial data rate Rᵢ automatically after the maximum tolerable delay Dᵢ without handshaking between the server and the client device.

15. The server of claim 14, wherein the initial data rate Rᵢ=B/Dᵢ.

16. The server of claim 14, wherein the initial data rate Rᵢ is set to be no greater than a maximum data rate supported by the client based on an initial quality of service profile.

17. The server of claim 14, wherein the initial data rate Rᵢ is achieved by the server allocating additional channel resources to the multimedia content streaming.

18. The server of claim 14, wherein the initial data rate Rᵢ is determined by at least one of the average data rate of transmission R and a maximum data rate supported by the client device.

19. A computer-readable recording medium recorded with a computer program for execution by a processor to perform a process to manage quality of service in a multimedia streaming system, the process comprising:
determining an initial quality of service profile defining an initial data transmission rate of multimedia content between a server and a client;
determining a steady state quality of service profile defining a subsequent data transmission rate of the multimedia content between the server and the client; and
setting a predefined point during streaming for switching over from the initial data transmission rate to the subsequent data transmission rate without handshaking between the server and the client at the switchover;
wherein the predefined point is set to minimize an initial delay in streaming the multimedia content from the server to the client and wherein the initial data transmission rate is higher than the subsequent data transmission rate.

20. A computer-readable recording medium recorded with a computer program for execution by a processor to perform a process to manage quality of service in a multimedia streaming system, the process comprising:
determining an average rate R of transmission for multimedia content to be streamed between a server and a client;
determining a number of bits B of the multimedia content to buffer at the client;
setting a maximum tolerable initial delay Dᵢ as part of an initial quality of service profile, wherein Dᵢ≦B/R;
setting an initial data rate Rᵢ, wherein data of the multimedia content will be transferred at the rate Rᵢ for Dᵢ seconds; and
setting a steady state data rate for continued streaming of the multimedia content, wherein the data of the multimedia content will be transferred at the steady state data rate after Dᵢ seconds have elapsed, the initial data rate Rᵢ being higher than the steady state data rate;
wherein switching from the initial data rate Rᵢ to the steady state data rate occurs automatically without handshaking between the server and the client.
